(19) United States
(12) Patent Application Publication
(10) Pub. No.: US 2014/0195924 A1
(43) Pub. Date: Jul. 10, 2014

(54) SYSTEM AND METHOD FOR CUSTOMIZED TIMELINE FOR ACCOUNT INFORMATION

(71) Applicant: ORACLE INTERNATIONAL CORPORATION, Redwood Shores, CA (US)

(72) Inventors: Wesley CURTIS, Cary, NC (US); Yaelle ATTAR, Dover Heights (AU)

(73) Assignee: ORACLE INTERNATIONAL CORPORATION, Redwood Shores, CA (US)

(21) Appl. No.: 13/803,727

(22) Filed: Mar. 14, 2013

Related U.S. Application Data
(60) Provisional application No. 61/750,451, filed on Jan. 9, 2013.

(51) Int. Cl. G06F 3/0484

(52) U.S. Cl. CPC G06F 3/0484
USPC 715/747

(57) ABSTRACT

Systems, methods, and other embodiments associated with customizing a timeline for displaying account information about an entity are described. In one embodiment, a method includes configuring a timeline of tax account information by consolidating a history of the tax account information in a display of the timeline. Elements in the history are selected based on parameters that have been customized for a revenue authority. The elements include display properties of the timeline and tax account information. The example method may also include dynamically rendering the timeline as one of multiple display zones on a display screen based, at least in part, on the parameters. Rendering the display includes determining how to display each of the elements on the timeline. The processor configures the timeline and dynamically renders the timeline in response to receiving a request to display the timeline about an entity.

### CROSS REFERENCE TO RELATED APPLICATIONS

This disclosure claims the benefit of U.S. Provisional Patent Application Ser. No. 61/750,451 filed Jan. 9, 2013, entitled “SYSTEM AND METHOD FOR CUSTOMIZED TIMELINE FOR ACCOUNT INFORMATION”, inventors: Wesley CURTIS and Yaelle ATTAR, and assigned to the present assignee and which is incorporated by reference in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Tax and revenue authorities (e.g., the Internal Revenue Service) provide customer support to taxpayers via representatives that interact with the taxpayers. However, the representatives often have difficulties quickly determining information about a taxpayer's account and answering questions for the taxpayer. This is especially true when the taxpayer has a complicated tax history that includes many different transactions, obligations, and cases. Typically, the representative must sift through many different menus and screens of a tax system that is full of information to attempt to manually search out information for the taxpayer. This results in reduced efficiency of the representative and often also results in a reduced quality of service.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a system associated with customizing a timeline of taxpayer account information.

FIG. 2 illustrates one embodiment of a method associated with customizing a timeline of taxpayer account information.

FIG. 3 illustrates an example screenshot of a timeline of tax payer account information for an entity.

FIG. 4 illustrates an example screenshot of an interface for customizing a timeline with an appeal case event timeline algorithm.

FIG. 5 illustrates an example screenshot of an interface for customizing a timeline with an audit case event timeline algorithm.

FIG. 6 illustrates an example screenshot of an interface for customizing a timeline with a suppression event timeline algorithm.

FIG. 7 illustrates an example screenshot of an interface for customizing a timeline with a tax form event timeline algorithm.

FIG. 8a illustrates an example screenshot of an interface for customizing a timeline with a collection case event timeline algorithm.

FIG. 8b illustrates an example screenshot of an interface for customizing a timeline with a collection case event timeline algorithm.

FIG. 9a illustrates an example screenshot of an interface for customizing a timeline with an audit case event timeline algorithm.

FIG. 9b illustrates an example screenshot of an interface for customizing a timeline with an audit case event timeline algorithm.

FIG. 10 illustrates an example screenshot of an interface for customizing a timeline zone with one or more timeline display algorithms.

FIG. 11 illustrates an embodiment of a computing system in which example systems and methods, and equivalents, may be implemented and operate.

### DETAILED DESCRIPTION

Systems, methods and other embodiments are described that are associated with customizing a timeline to display taxpayer account information. Taxpayer account information can include many intricate details comprising different dates for different cases, transactions, obligations, and activities. This creates a complex set of data associated to a taxpayer's account. As stated previously, a customer service representative (at a tax agency) would typically search a computerized tax system by navigating through many different menus and displays to find relevant information from the taxpayer account information. The searching and navigating can be a slow process, which can negatively impact customer service.

Accordingly, in one embodiment, a computerized timeline is generated and configured to consolidate taxpayer account information for an entity (e.g., a person or corporation) into a single timeline or even a single view of a timeline so that finding and analyzing details about the taxpayer account information is improved. Additionally, the tax system is configured to provide an interface for customizing the timeline by exposing parameters embedded in program logic of the tax system that are not typically accessible by an end user of the tax system. In this way, the timeline can be configured to display the tax account information in a single view that is customized to streamline interactions by a user (e.g., customer service representative).

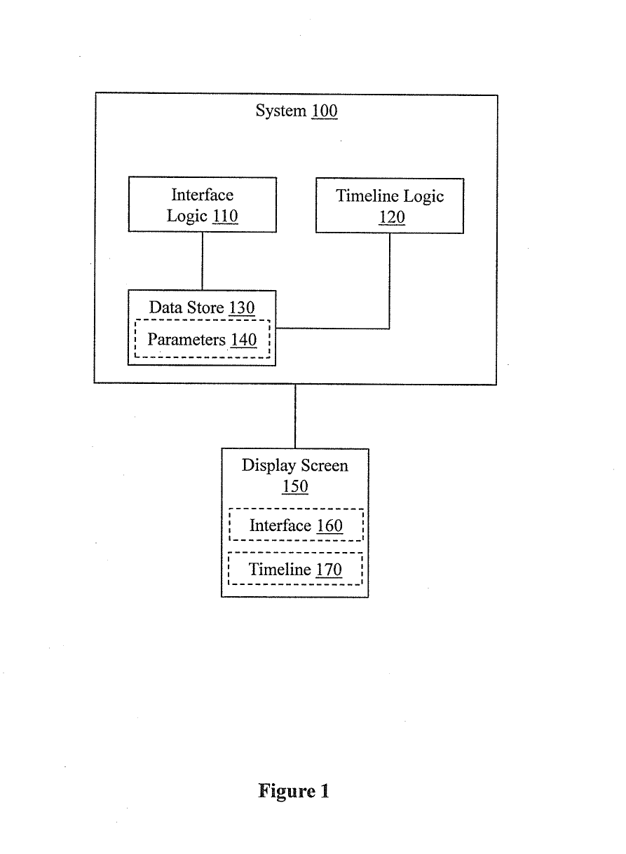

With reference to FIG. 1, one embodiment of a system 100 associated with customizing a timeline is illustrated. The system 100 includes interface logic 110, timeline logic 120, and a data store 130. The data store 130 includes parameters 140. The system 100 is configured to communicate with a display screen 150 in order to display an interface 160 and a timeline 170 to users. In one embodiment, the system 100 is a computer, server, or other device that electronically stores and processes data and the display screen 150 is a display screen of the system 100 or a display screen of a remote device (not shown).

Consider that managing a tax/revenue program, even at a modest level, can be a very complex task. This is because; in general, a revenue authority (e.g., The IRS) maintains documents, forms, and other records for each entity (e.g., individuals, corporations, etc.) that is obligated to pay taxes/fees and/or file documents. Therefore, the revenue authority must maintain large amounts of tax account information relating to numerous amounts of entities.

The revenue authority is, for example, a local government, state government, federal government (e.g., IRS), or more generally any authority that collects taxes/revenues from many different entities. In one embodiment, the revenue authority implements the system 100 to maintain the large amounts of tax account information concerning the entities. The revenue authority uses the system 100 to access/manage the tax account information, which can include transactions, obligations, and other information concerning interactions with the entities. This complex assortment of tax account information can frustrate representatives (e.g., customer service representatives, case workers, etc.) tasked with helping the entities resolve issues or difficulties with their account. Thus in one embodiment, the system 100 is configured to improve navigating and analyzing functions for the tax account information by providing a consolidated all-in-one view of the tax account information for an entity.

For example, to improve navigation of the tax account information, the interface logic 110 is configured to expose the parameters 140 that are part of program logic in the system 100 in order to permit customization of the timeline 170. For example, the parameters 140 are identified within the program logic (e.g., computer code) and the interface logic 110 provides access to modify the parameters. In one embodiment, the interface logic 110 is configured to generate the interface 160 to expose the parameters 140 to a user. The user is, for example, an individual that is tasked with implementing the system 100. That is, the user is a technical support or other individual that installs the system 100 for use by the tax authority. Accordingly, the interface 160 provided by the interface logic 110 permits modifying the parameters 140, which control how the timeline logic 120 generates timeline 170 for an entity.

In one embodiment, the parameters 140 include different options for configuring which elements from the tax account information are included within the timeline 170 and for configuring a look and feel of the timeline 170 (e.g. graphical/visual display parameters). The options to control the look and feel include, for example, options to control colors of elements on the timeline 170, options to control types/styles of icons, and so on. The parameters 140 that control the elements that are included within the timeline 170 include, for example, different options that when selected cause different algorithms to be used when generating the timeline 170. For example, the interface logic 110 generates the interface 160 with selections for including appeal case algorithms, audit case algorithms, suppression algorithms, tax form algorithms, collection case algorithms, payment algorithms, transactions and process algorithms, and so on.

When selected on the interface 160, each selected algorithm is configured so that different information from an entity's tax payer account information is consolidated and displayed on the timeline 170. As an example consider that when the appeal case algorithm is selected from the interface 160, elements for events about appeals linked to the entity's taxpayer account are displayed on the timeline 170. However, if the appeal case algorithm is not selected, then this information is not displayed in the timeline 170.

The interface logic 110 generates the interface 160 to not only expose the parameters 140 that permit including different algorithms and for controlling a general look and feel of the timeline 170, but the interface 160 is also generated to expose the parameters 140 that control how elements included by the algorithms will look when displayed on the timeline 170. That is, the interface logic 110 provides access to look and feel options (e.g., color, icon type, etc.) for information included on the timeline 170 by selected algorithms. The look and feel options can include a type of icon displayed for an event (e.g., different icons for different types of events or events with a different status), a color of an icon displayed for an event, background colors, colors and styles of fonts, actions that occur when an event is selected, and so on.

To control the options, the interface logic 110 is configured to receive input via the interface 160 and to modify the parameters 140 according to selections defined by the input of a user through the interface 160. In general, the interface 160 is used to modify the parameters 110 when the system 100 is initially implemented or installed. However, in one embodiment, the interface logic 110 is configured to modify the parameters 140 based on input received through the interface 160 at any point in time during the use of the system 100.

After the parameters 140 are modified/customized, the timeline logic 120 generates the timeline 170 according to the customized parameters 140. The timeline logic 120 is configured to generate the timeline 170 about a specific entity in response to a request to display the timeline 170 about the entity.

Consider an example where the system 100 is used by customer service representatives of a tax authority such as the Internal Revenue Service (IRS), A representative interacts with the system 100 through, for example, a remote terminal or other device using a graphical user interface (GUI), which may also be generated by the tax system. Thus, upon receiving an inquiry about an entity's (e.g., John Doe) tax account information, the representative initiates a request to the system 100 that identifies John Doe to the system 100 and requests the timeline 170. In response to the request, the timeline logic 120 configures and renders the timeline 170 using account information retrieved from various records associated to the entity.

For example, the timeline logic 120 configures the timeline 170 by first consolidating a history of tax account information for John Doe. The history includes events and dates of the events for placing the events on the timeline 170. The timeline logic 120 selects the events according to which algorithms are defined by the parameters 140 to include within the timeline 170. The timeline logic 120 consolidates the information by, for example, executing the selected algorithms which each parse the tax account information for John Doe and return algorithm specific information (e.g., appeal case events for an appeal algorithm or collection case events for a collections algorithm). Once the timeline logic 120 consolidates the history of the tax account information for John Doe the timeline logic 120 may adjust a scale of the timeline 170 in order to fit all (or a selected portion) of the history into a single view. Alternatively, the timeline logic 120 configures the timeline 170 into a scrolling timeline with the history viewable by the user scrolling through a continuous single timeline.

The timeline logic 120 configures and selects elements displayed on the timeline 170 based on the parameters 140 and an identity of an entity in the request. That is, the timeline logic 120 generates the timeline 170 to display information and events relating to John Doe's tax account with the IRS using customized algorithms specified by the parameters 140. Each time the timeline logic 120 receives a request, a different version of the timeline 170 is generated because each entity has different tax account information which is consolidated and then rendered for display on the timeline 170.

Accordingly, the timeline logic 120 is configured to dynamically render a display of the timeline 170 on a display screen 150 by determining how to display each of the elements on the timeline 170 for the specific entity (e.g., John Doe). As previously discussed, the timeline logic 120 is configured to determine which information is present in an entity's tax account information according to the selected algorithms and after the tax account information is consolidated the timeline logic 170 determines how to display (e.g., color, icon, etc.) the information based on the parameters 140.

Consider an example where John Doe's tax account information includes both resolved and open appeal cases. The timeline 170 for John Doe's account displays, for example, dates of significant events for these cases and may display resolved appeal case events in a different color or icon style than open appeals case, as defined by the parameters 140 (e.g., visually distinguish different types of cases). In this way, the system 100 streamlines display of the tax account information in order to display a user friendly format that is more easily navigated by a customer service representative.

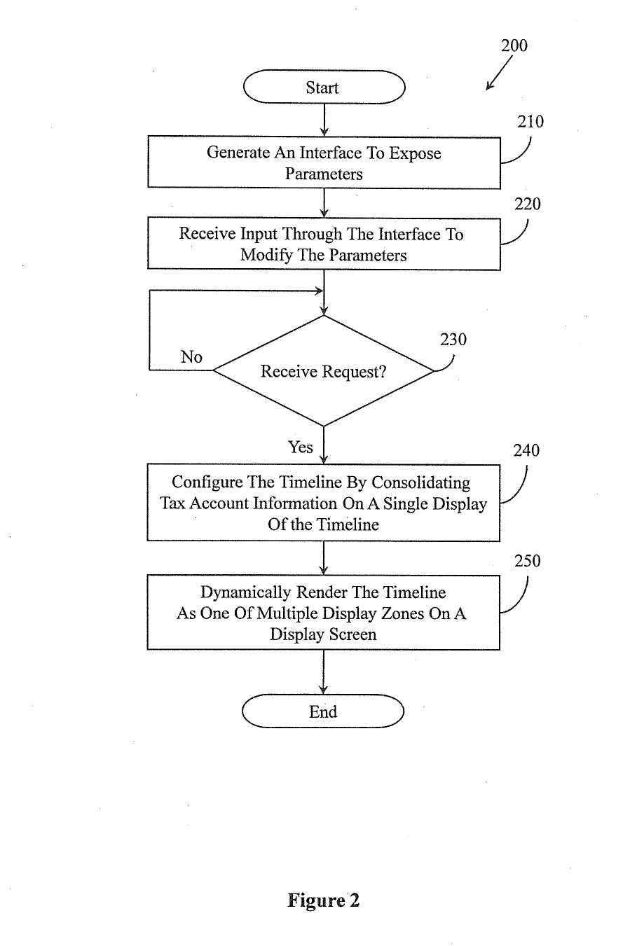

Further details of generating the timeline 170 will be discussed with reference to FIG. 2, FIG. 2 illustrates a computer-implemented method 200 associated with customizing a timeline of taxpayer account information. FIG. 2 will be discussed from the perspective of the system 100 of FIG. 1.

At 210, the system 100 generates an interface (e.g., interface 160) to expose parameters to a user for customizing a timeline (e.g., timeline 170). The interface can be provided to a remote device or a local display screen of the system 100 for display and interaction by the user. The interface permits a technical support person or other individual that implements the system 100 to adapt how the system 100 generates the timeline so that the timeline is tailored for a specific revenue authority that is implementing the system 100. As stated previously, the parameters exposed by the interface are part of program logic of the system 100 that includes variables, functions, and so on that produce the timeline (e.g., parameters from a software application).

In general, the system 100 generates the interface with options for all parameters in the system 100 that can be modified/customized without requiring the parameters to be hard programmed to realize customized features. That is, the parameters are exposed through the interface in order to permit reduced effort to customize the timeline and to not require customized features to be hard coded by software developers of the system 100. Accordingly, the interface may include multiple screens, tabs, or other methods of selecting between groupings of options in order to permit access to the various parameters of the system 100. In this way, the technical support individual selects which elements (e.g., tax account information) to include on the timeline and how (e.g., color, icon type, date ranges, context, tax role, and so on) to display the elements.

At 220, the system 100 receives input through the interface that designates which parameters to modify. For example, the technical support individual uses the interface to input selections and preferences for the various parameters that are exposed through the interface. Once the technical support individual has input the selections and preferences they are passed to the system 100 by the interface. The system 100, upon receiving the input from the interface, modifies the parameters that are stored in the system 100 to reflect the input provided by the technical support individual. Accordingly, the system 100 permits a user to modify the parameters and thus to customize the timeline, which is generated as a function of the parameters. Once the parameters are modified at 220, the system 100 is ready to generate the timeline. Furthermore, the parameters may remain accessible through the interface while timelines are being generated and the system 100 is in use. However in one embodiment, the interface is generally not a front end user service for setting preferences, but is rather a setup utility or other backend service that is used infrequently to customize aspects of the timeline.

Continuing with method 200, at 230, the system 100 determines whether a request to display a timeline for an entity has been received. If the system 100 receives a request at 230, then the method proceeds to 240, otherwise the system 100 continues to wait for a request. In general, a request is generated by a user (e.g., customer service representative) of the system 100 in response to a need to view tax account information for an entity (e.g., tax payer). However, in one embodiment, the requests are automatically generated upon a user login or other computer driven event.

At 240, the system 100 configures the timeline by retrieving data from various stored locations and consolidating tax account information for an entity identified in the request. For example, consolidating the tax account information includes initiating the selected algorithms to collect data from the entity's tax account information. The tax account information returned by the algorithms may include events and other information concerning collection cases, audit cases, appeal cases, statuses of cases, tax forms, tax form statuses, payment plan information, tax transactions for the entity, tax activities for the entity, and so on depending on selections to customize the timeline from the parameters.

In one embodiment, the system 100 consolidates the tax account information into a single view of the timeline. Additionally, the system 100 may display only information for a date range specified in the request or as customized in the parameters. For example, the parameters can specify that a history of only the previous four years of tax account information be displayed. Thus, depending on a timeframe or date range specified in the parameters only information for the specified time period is displayed on the timeline.

In one embodiment, at 240, the system 100 screens elements (i.e., confidential information) from being displayed on the timeline. For example, the system 100 screens elements based, at least in part, on a security level of a user (e.g., customer service representative). The system 100 may screen elements in order to secure certain information from unauthorized users or to secure internal information that should not be shared with an entity. Consider that the tax account information for an entity can include highly sensitive personal information (e.g., social security number, date of birth, and so on). Further consider that the revenue authority employs many different classes of employees. Some of the employees may need access to the sensitive information, while some may not. Accordingly, the parameters may include an algorithm for screening information. When selected a screening algorithm only permits certain information to be displayed to an employee depending on a security/trust level of the employee. In this way, tax account information is secure from malicious use by unauthorized individuals.

Once the information for the entity is collected, the method 200 proceeds to block 250. At 250, the system 100 dynamically renders the timeline as one of multiple display zones on a display screen (e.g., display screen 150). In one embodiment, the system 100 applies options as defined in the parameters at 220 to the information collected at 240. That is, the system 100 formats the timeline according to the modified parameters from block 220. For example, the parameters may specify that events for the tax account information on the timeline with a different status be generated with different colors or different icons.

Accordingly, the system 100 determines format/display preferences from the parameters and renders the timeline accordingly (e.g., with icons that have different colors for different statuses). Other preferences include, for example, background colors for the timeline, text color, display icon type, and so on. Upon applying these options to the elements of the timeline, the timeline is rendered and displayed on a display screen. In one embodiment, the timeline is displayed within a larger tax system that includes other display zones. The display zones include, for example, pop out information for selected events on the timeline, contact information for the entity, zones for notes about contact with the entity, query zones, portals, and so on.

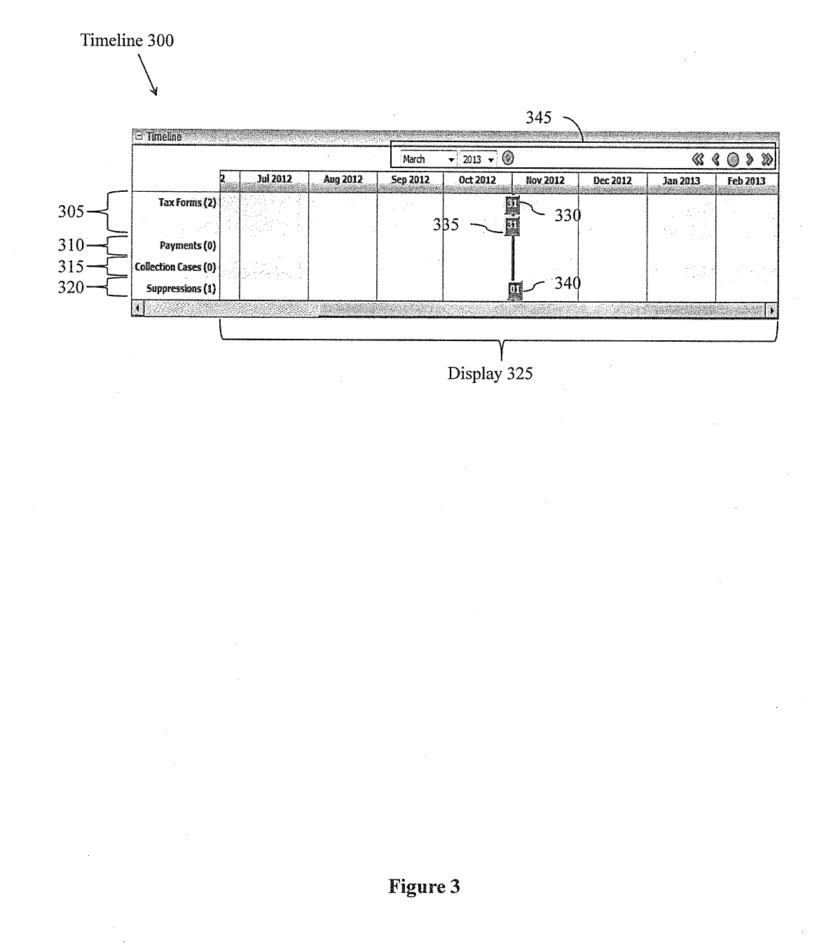

Further aspects of the timeline and the system 100 will be discussed with reference to example screenshots of the interface and the timeline. FIGS. 3-11 illustrate examples of the interface (e.g., interface 160 of FIG. 1) and the timeline (e.g., timeline 170 of FIG. 1). FIGS. 3-11 will be discussed from the perspective of the system 100 of FIG. 1.

FIG. 3 illustrates one embodiment of a timeline 300 of tax payer account information for an entity that may be generated by system 100 or method 200. The timeline 300 is illustrated with four separate rows but any number of rows may be included. The rows include a tax forms row 305, a payments row 310, a collection cases row 315, and a suppressions row 320. Each row 305-320 corresponds to an algorithm selected from the parameters (e.g., parameters 140 of FIG. 1). For example, the tax forms row 305 corresponds to a tax form algorithm selected from the interface (e.g., the interface 160 of FIG. 1), which then caused the selected algorithm to execute. Accordingly, for the timeline 300 to be generated as shown in FIG. 3, parameters for including the tax form algorithm were selected from the interface. In turn, the system 100 generated the timeline 300 using the tax form algorithm, which caused the tax form row 305 to be displayed with information from the entity's tax account information. Similarly, a payments algorithm, a collection cases algorithm, and a suppressions algorithm were selected through the interface to cause the system 100 to generate the timeline 300 with rows 310-320, respectively, that show data generated or retrieved by the associated algorithm.

An information display region 325 displays elements 330, 335, and 340 on columns identified by months (e.g., ranging from July 2012 to February 2012 in FIG. 3). In general, the information display region 325 displays information consolidated by the algorithms. The elements 330, 335, and 340 are displayed as icons (e.g., shown as square icons) with a day of the month displayed in the middle of each icon for when an event that corresponds to the element occurred. In one embodiment, a mouse-over or click of each element 330, 335, and 340 generates a popup with additional information. In addition to elements 330, 335, and 340 displayed as an icon with a day of the month, the elements 330 and 335 are displayed in a first color (e.g., green), while the element 340 is displayed in a second color (e.g., red). Using different colors in this way indicates, for example, a different status of events associated with each element. These color preferences, icon preferences, and date range preferences are all examples of customized parameters (e.g., parameters 140) used when the timeline 300 was generated.

The information display region 325 also includes a scroll bar located at the bottom for scrolling to different dates that are not shown due to space limitations for the example timeline 300. While the timeline 300 is shown with a scroll bar other embodiments of the timeline 300 may use a different scale to fit all elements into a single view. The timeline 300 also includes controls 345 for selecting different display options including different date ranges.

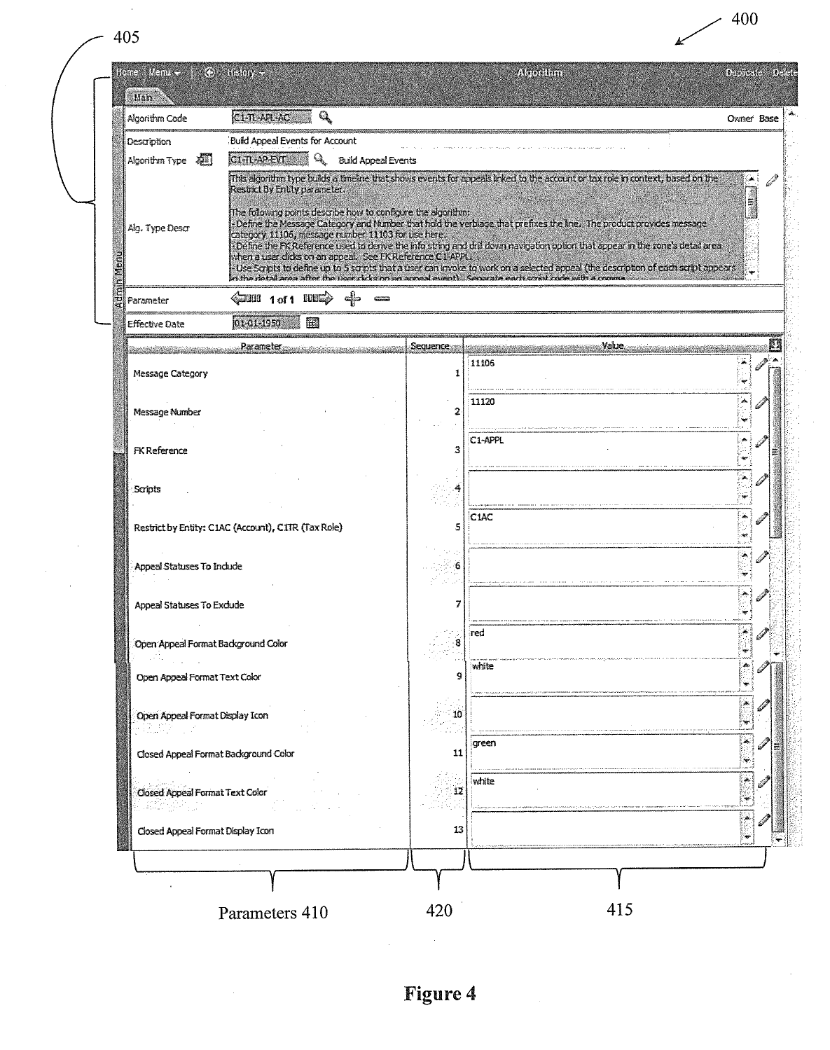

FIG. 4 illustrates an example screenshot and display of a graphical user interface 400 for customizing a timeline with an appeal case event timeline algorithm. The interface 400 illustrates different options for customizing an appeal case event timeline algorithm. The appeal case event timeline algorithm, when selected to be included on a timeline, causes information about appeals in an entity's tax account information to be included. The interface 400 includes options section 405, which displays general information about the appeal case event timeline algorithm (e.g., algorithm type, description, detailed description). The options section 405 also includes a parameter option and an effective date option. The parameter option and the effective date option permit defining sets of parameters that are in effect from a point in time specified by the effective date option. For example, multiple sets of parameters 410 can be defined with different values to take effect at different times.

The interface 400 also includes a list of parameters 410 (i.e., parameters 140 of FIG. 1) that can be customized for the appeal case event timeline algorithm. In addition to listing the parameters 410 for customizing the appeal case event timeline algorithm, the interface 400 includes custom value fields 415 and a sequence field 420. The custom value fields 415 permit a user to input custom values (e.g., scripts, macros, functions, colors, and so on) for the parameters 410 and not simply select from predefined values or predefined parameters. Accordingly, the interface 400 permits customization because values for parameters are not restricted to predefined values, but can be instead be defined on-the-fly. A user of the interface 400 interacts with the options section 405, and custom value fields 415 to customize the appeal case algorithm and to generate input that is provided to the system 100 for modifying the parameters 140 of FIG. 1. As displayed on the interface 400, the parameters 410 that can be modified include message category, message number, field key (FK) reference, scripts, restrict by entity, appeal statuses to include, appeal statuses to exclude, open appeal format background color, open appeal format text color, open appeal format display icon, closed appeal format background color, closed appeal format text color, and closed appeal format display icon. Of course, the parameters 410 may include more or less parameters than those shown in FIG. 4.

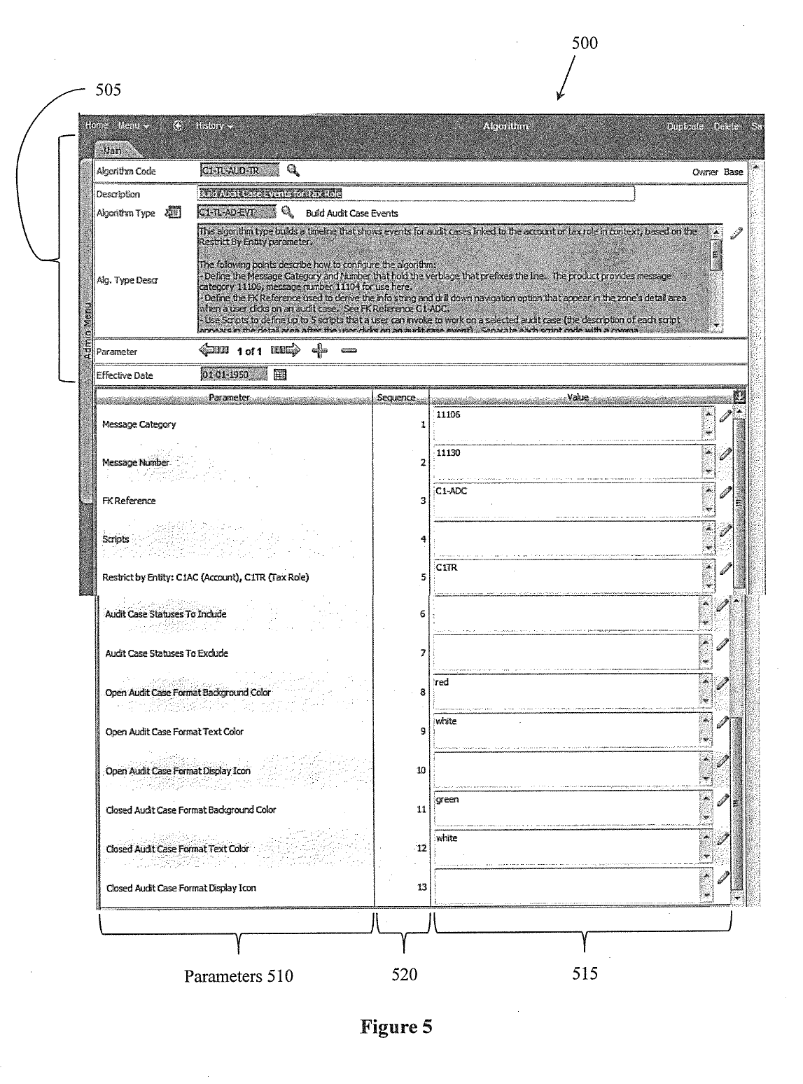

FIG. 5 illustrates an example screenshot and display of a graphical user interface 500 for customizing a timeline with an audit case event timeline algorithm. The interface 500 includes elements similar to those of the interface 400 of FIG. 4 except with reference to the audit case event timeline algorithm. For example, the interface 500 includes options section 505, parameters 510, and custom value fields 515, and sequence fields 520. Accordingly, the audit case event timeline algorithm is customizable in a similar manner to the appeal case event timeline algorithm.

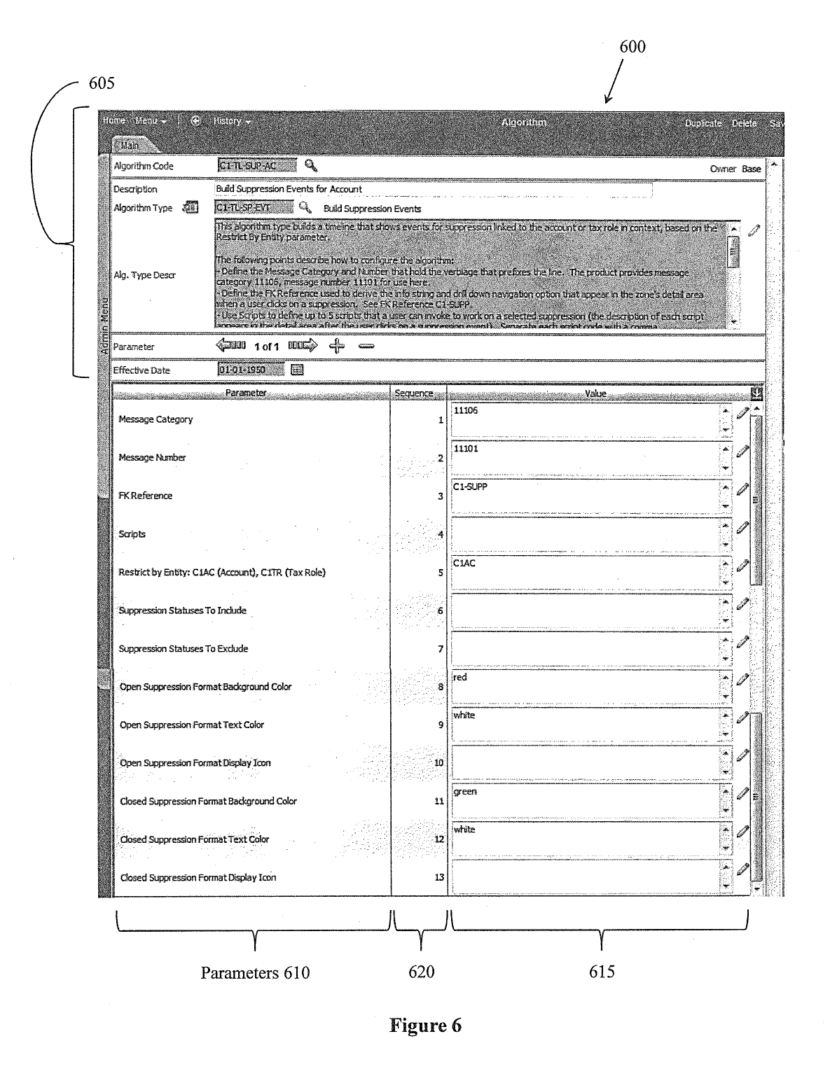

FIG. 6 illustrates an example screenshot and display of a graphical user interface 600 for customizing a timeline with a suppression event timeline algorithm. The interface 600 includes elements similar to those of the interface 400 of FIG. 4 except with reference to the suppression event timeline algorithm. For example, the interface 600 includes options section 605, parameters 610, and custom value fields 615, and sequence fields 620. Accordingly, the suppression event timeline algorithm is customizable in a similar manner to the appeal case event timeline algorithm.

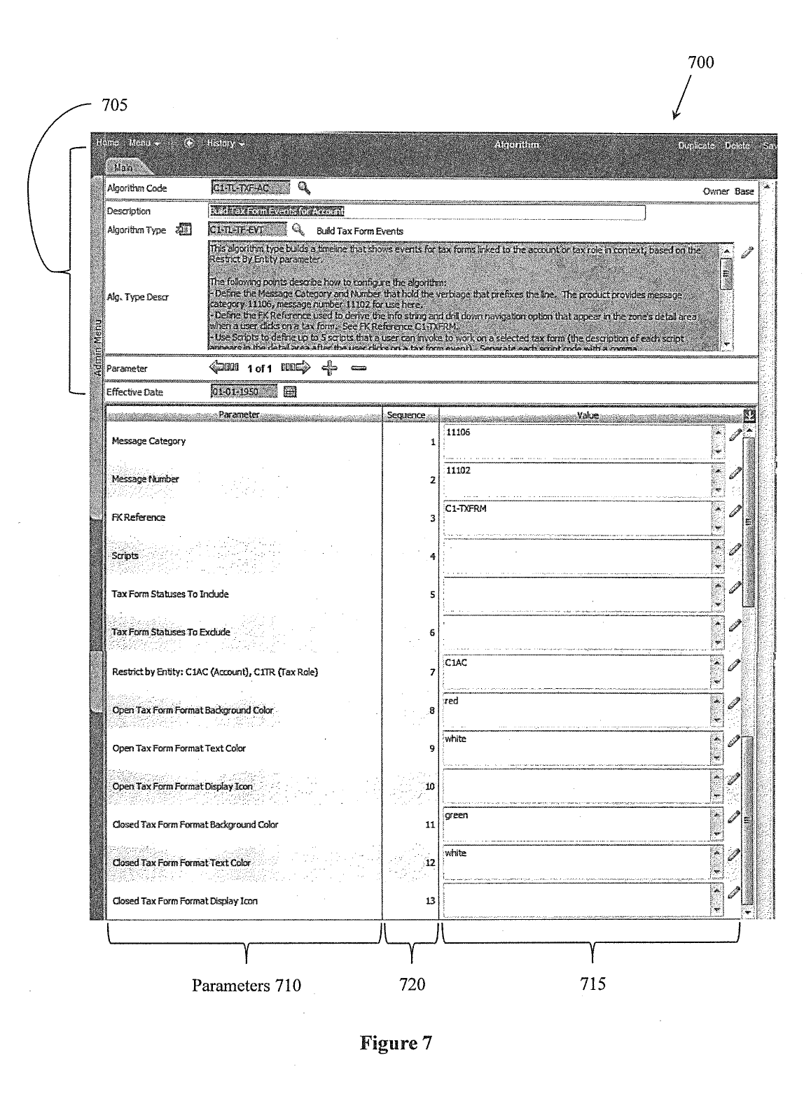

FIG. 7 illustrates another example screenshot of a graphical user interface 700 for customizing a timeline with a tax form event timeline algorithm. The interface 700 includes elements similar to those of the interface 400 of FIG. 4 except with reference to the tax form event timeline algorithm. For example, the interface 700 includes options section 705, parameters 710, and custom value fields 715, and sequence fields 720. Accordingly, the tax form event timeline algorithm is customizable in a similar manner to the appeal case event timeline algorithm.

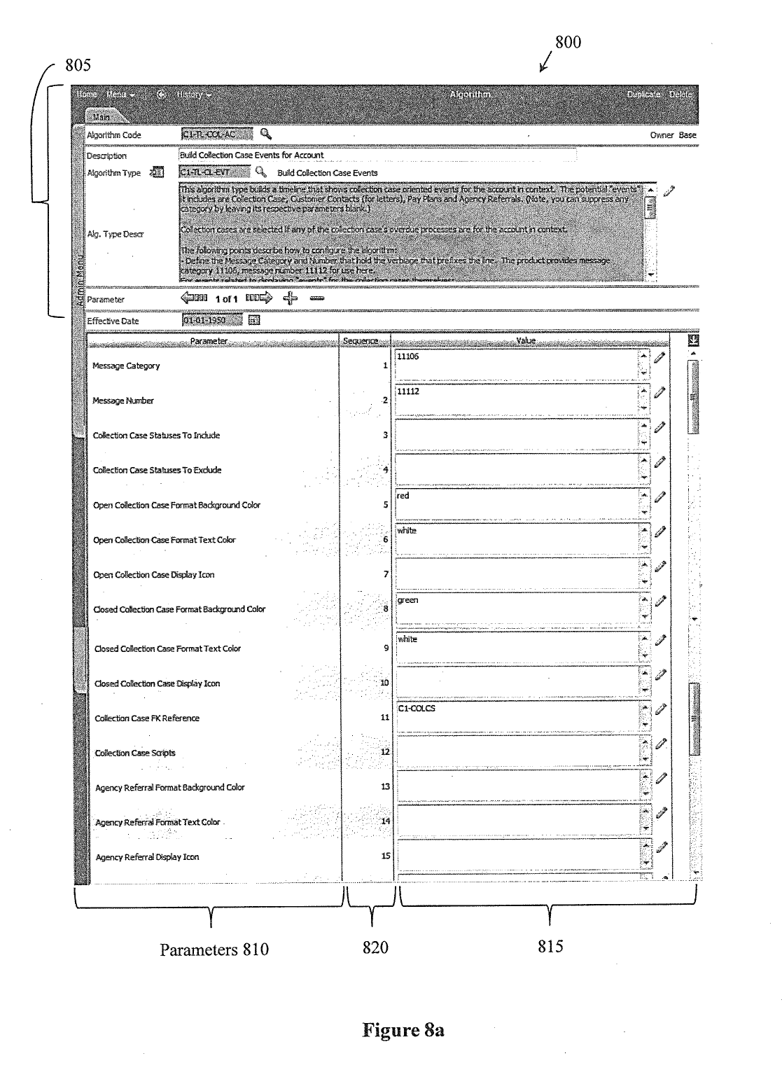

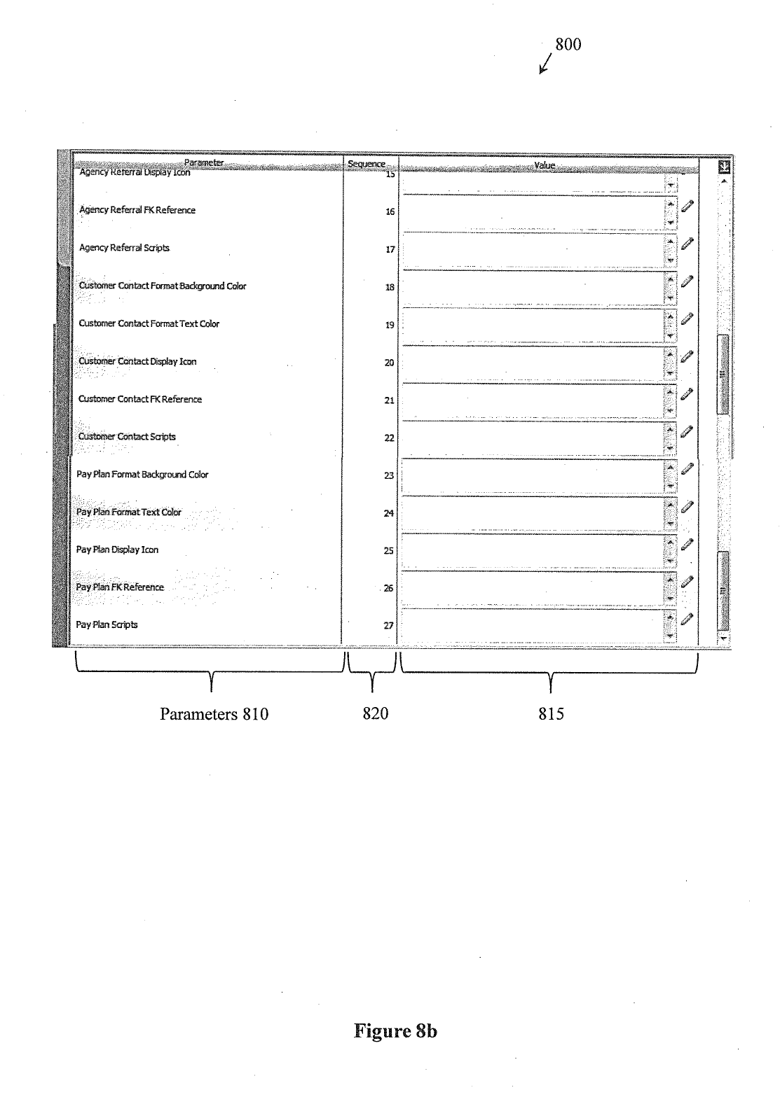

FIG. 8, which is composed of FIGS. 8a and 8b, illustrates an example screenshot of a graphical user interface 800 for customizing a timeline with a collection case event timeline algorithm. The interface 800 includes elements similar to those of the interface 400 of FIG. 4 except with reference to the collection case event timeline algorithm. For example, the interface 800 includes options section 805, parameters 810, and custom value fields 815, and sequence fields 820. Accordingly, the collection case event timeline algorithm is customizable in a similar manner to the appeal case event timeline algorithm.

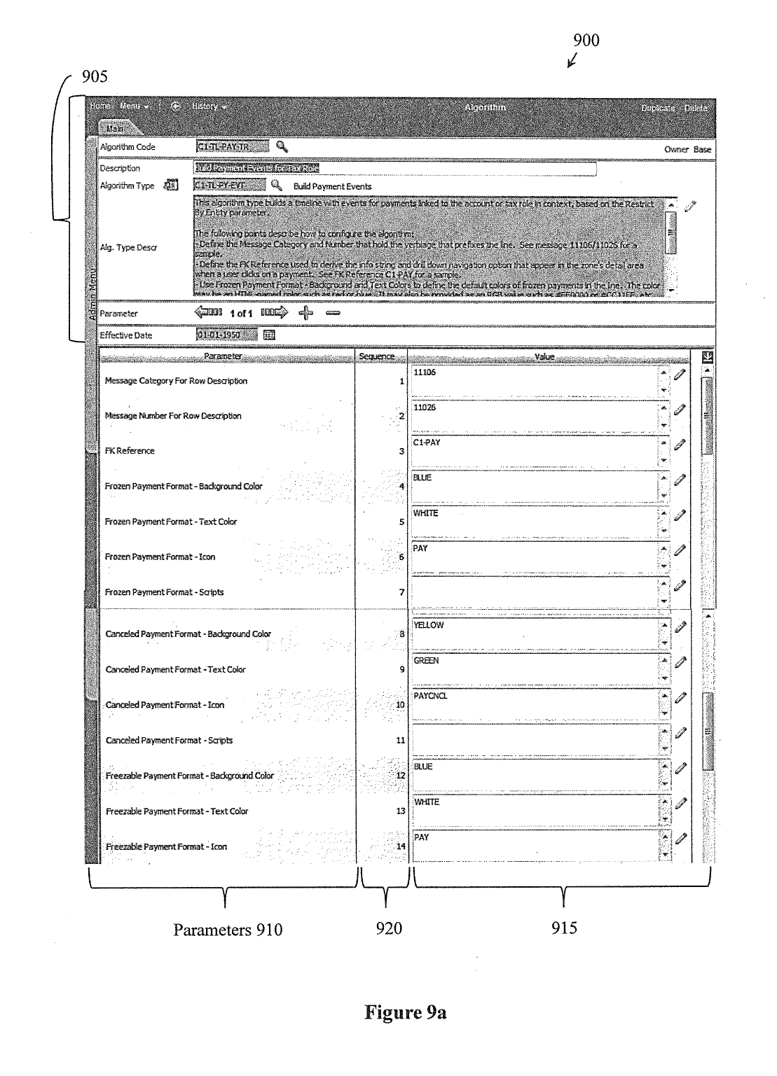

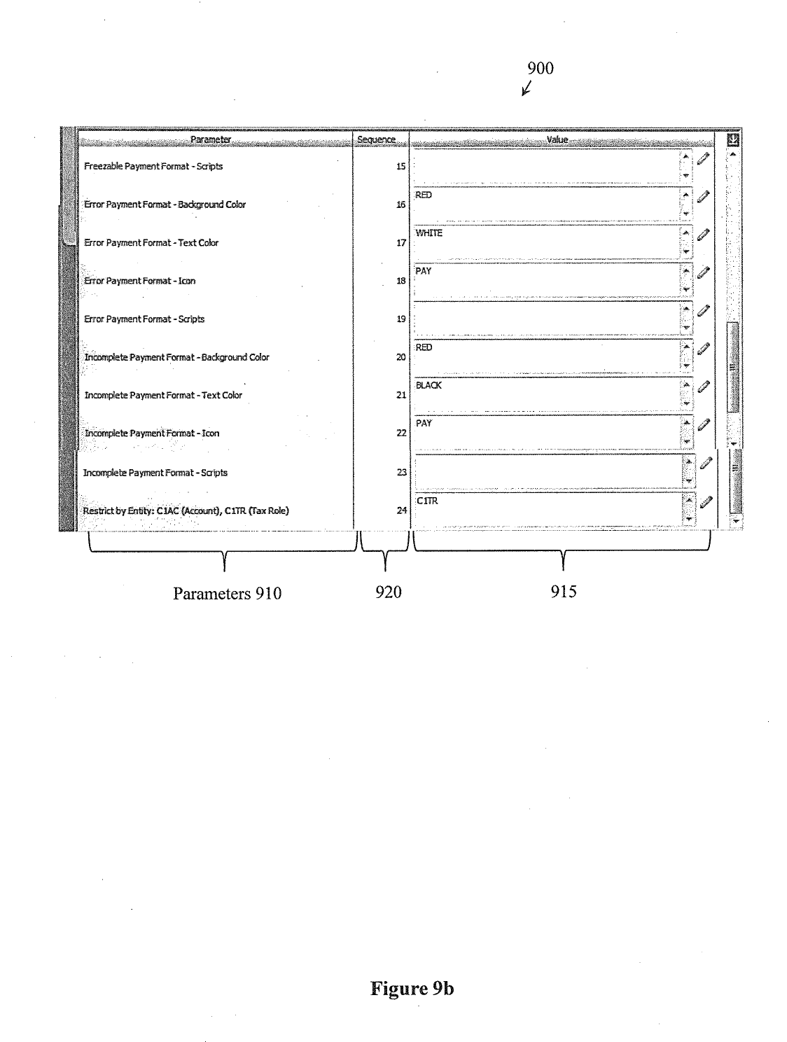

FIG. 9, which is composed of FIGS. 9a and 9b, illustrates an example screenshot of a graphical user interface 900 for customizing a timeline with a payment events timeline algorithm. The interface 900 includes elements similar to those of the interface 400 of FIG. 4 except with reference to the payment events timeline algorithm. For example, the interface 900 includes options section 905, parameters 910, and custom value fields 915, and sequence fields 920. Accordingly, the payment events timeline algorithm is customizable in a similar manner to the appeal case event timeline algorithm.

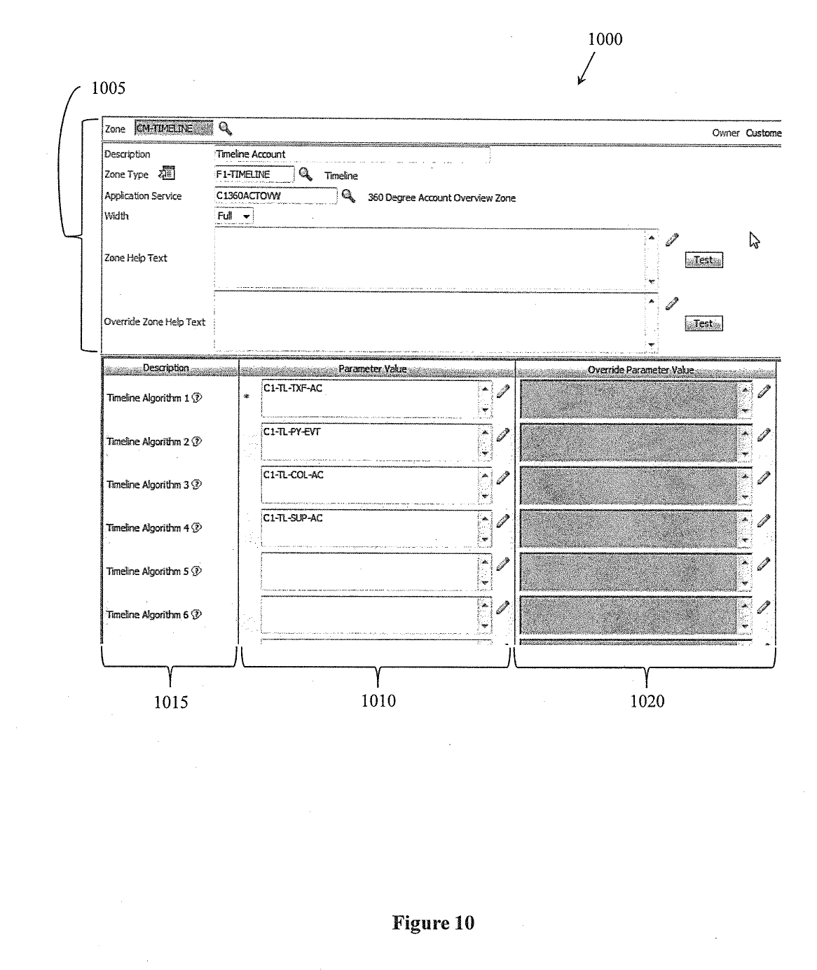

FIG. 10 illustrates an example screenshot of a graphical user interface 1000 for customizing a zone timeline with one or more timeline display algorithms. The interface 1000 illustrates one embodiment of a main interface screen where the timeline display algorithms are configured. The timeline display algorithm parameters control which algorithms from interfaces 400-900 are included with the timeline and other general format options of the timeline. For example, the interface 1000 includes a general description and options section 1005, which includes a description, a zone type, an application service, a width, a zone help text, and an override zone help text field. The zone type field defines the behavior (e.g., scrolling actions, and so on) of the zone in a portal. The zone is, for example, a space reserved for displaying the timeline within a larger tax system that displays many different windows/portals to a user at one time. The Application service field controls who has access to the zone. The width field defines the size of the zone within the portal in which the timeline is displayed (e.g., full, partial, and so on).

The interface 1000 also includes a parameter value column 1010, which is where names of algorithms are entered if information from the algorithms is to be included on the timeline when generated. For example, for each row of the column 1010 that includes an algorithm, an additional row with information from that algorithm will be displayed on the timeline (e.g., the timeline 170). A description column 1015 numbers the included algorithms and an override parameter value column 1020 permits a user to enter an override value for each algorithm.

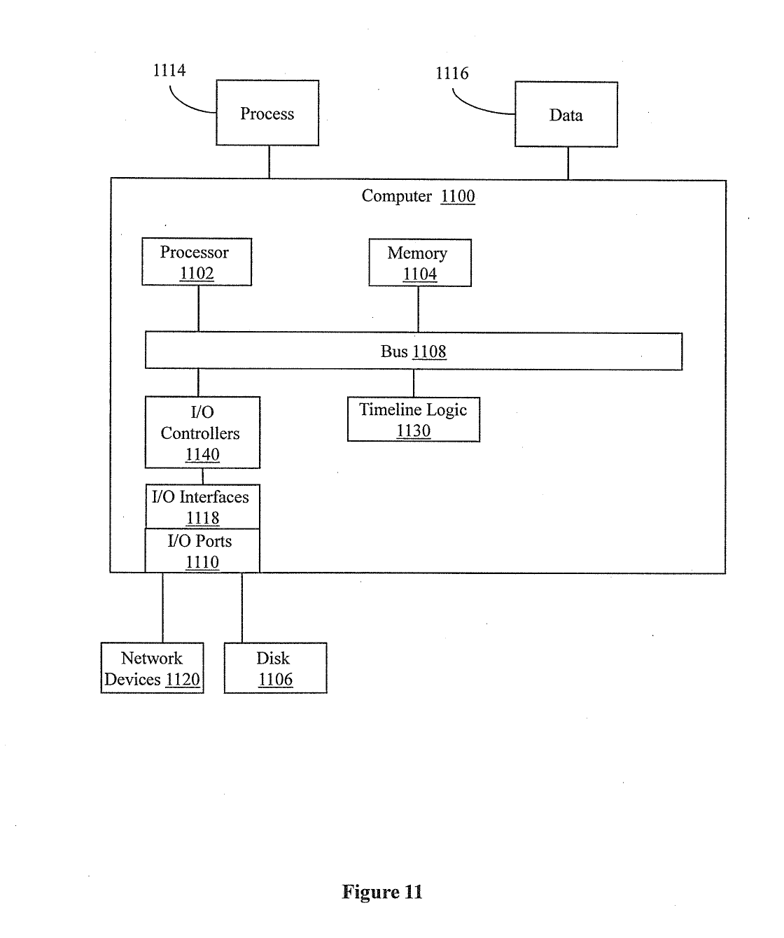

FIG. 11 illustrates an example computing device in which the systems and methods described herein, and equivalents, may be implemented and operate. The example computing device may be a computer 1100 that includes a processor 1102, a memory 1104, and input/output ports 1110 operably connected by a bus 1108. In one example, the computer 1100 includes timeline logic 1130 configured to permit a user to customize timelines displayed by a tax system and to generate the timelines dynamically for an entity based upon customized parameters. In different examples, the timeline logic 1130 may be implemented in hardware, a non-transitory computer-readable medium with stored instructions, firmware, and/or combinations thereof. While the logic 1130 is illustrated as a computer component attached to the bus 1108, it is to be appreciated that in one example, the logic 1130 could be implemented in the processor 1102 or as part of a executable application. In one embodiment, timeline logic 1130 is configured as timeline logic 120 from FIG. 1 or configured to perform the method 200 from FIG. 2.

Generally describing an example configuration of the computer 1100, the processor 1102 may be a variety of various processors including dual microprocessor and other multi-processor architectures. A memory 1104 may include volatile memory and/or non-volatile memory. Non-volatile memory may include, for example, ROM, PROM, and so on. Volatile memory may include, for example, RAM, SRAM, DRAM, and so on.

A disk 1106 may be operably connected to the computer 1100 via, for example, an input/output interface (e.g., card, device) 1118 and an input/output port 1110. The disk 1106 may be, for example, a magnetic disk drive, a solid state disk drive, a floppy disk drive, a tape drive, a Zip drive, a flash memory card, a memory stick, and so on. Furthermore, the disk 1106 may be a CD-ROM drive, a CD-R drive, a CD-RW drive, a DVD ROM, and so on. The memory 1104 can store a process 1114 and/or a data 1116, for example. The disk 1106 and/or the memory 1104 can store an operating system that controls and allocates resources of the computer 1100.

The bus 1108 may be a single internal bus interconnect architecture and/or other bus or mesh architectures. While a single bus is illustrated, it is to be appreciated that the computer 1100 may communicate with various devices, logics, and peripherals using other busses (e.g., PCIE, 1394, USB, Ethernet). The bus 1108 can be types including, for example, a memory bus, a memory controller, a peripheral bus, an external bus, a crossbar switch, and/or a local bus.

The computer 1100 may interact with input/output devices via the i/o interfaces 1118 and the input/output ports 1110. Input/output devices may be, for example, a keyboard, a microphone, a pointing and selection device, cameras, video cards, displays, the disk 1106, the network devices 1120, and so on. The input/output ports 1110 may include, for example, serial ports, parallel ports, and USB ports.

The computer 1100 can operate in a network environment and thus may be connected to the network devices 1120 via the i/o interfaces 1118, and/or the i/o ports 1110. Through the network devices 1120, the computer 1100 may interact with a network. Through the network, the computer 1100 may be logically connected to remote computers. Networks with which the computer 1100 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Logic”, as used herein, includes a computer or electrical hardware component(s), firmware, a non-transitory computer readable medium that stores instructions, and/or combinations of these components configured to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions that when executed perform an algorithm, and so on. Logic may include one or more gates, combinations of gates, or other circuit components. Where multiple logics are described, it may be possible to incorporate the multiple logics into one physical logic component. Similarly, where a single logic unit is described, it may be possible to distribute that single logic unit between multiple physical logic components.

“User”, as used herein, includes but is not limited to one or more persons, computers or other devices, or combinations of these.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

What is claimed is:

1. A non-transitory computer-readable medium storing computer-executable instructions that when executed by a computer cause the computer to perform a method, the method comprising:
generating, by a processor in the computer, an interface for generating and customizing a timeline, wherein the interface exposes parameters for modifying elements of the timeline, and wherein the elements include display properties of the timeline;
receiving input through the interface to modify the parameters, wherein the input includes input that selects which of the elements to include on the timeline and how to display the elements;
upon receiving a request to display the timeline with tax account information for an entity:
configuring the timeline by retrieving and consolidating a history of tax account information for the entity in a single display of the timeline, wherein elements in the history are selected based on the parameters; and
dynamically rendering the timeline as one of multiple display zones on a display screen based on the parameters, wherein rendering the timeline includes determining how to display each of the elements on the timeline based, at least in part, on the parameters, and wherein the multiple zones display tax information about the entity from a tax authority.

2. The non-transitory computer-readable medium of claim 1, further comprising:
screening elements from being displayed on the timeline based, at least in part, on the parameters and a security level of a user.

3. The non-transitory computer-readable medium of claim 1, wherein the interface exposes the parameters that are embedded in logic of the computer and are protected from being modified without the interface.

4. The non-transitory computer-readable medium of claim 1, wherein retrieving the tax information includes retrieving data associated with collection cases, audit cases, appeal cases, statuses of cases, tax forms, tax form statuses, payment plan information, tax transactions for the entity, and tax activities for the entity.

5. The non-transitory computer-readable medium of claim 1, wherein the elements include configurable algorithms for customizing display of the tax information on the timeline, and wherein the configurable algorithms each include a plurality of selectable options that are displayed on the interface.

6. The non-transitory computer-readable medium of claim 1, wherein configuring the timeline by consolidating the history of tax account information includes consolidating the history of tax account information for a selected time period.

7. The non-transitory computer-readable medium of claim 1, wherein the parameters include parameters that control which icons are displayed on the timeline to represent different events in the tax account information and parameters that control which colors are displayed on the timeline.

8. A computing system, comprising:
interface logic configured to generate an interface for customizing a timeline, wherein the interface exposes parameters for modifying elements of the timeline, and wherein the elements include display properties of the timeline and tax account information,
wherein the interface logic is configured to receive input through the interface to modify the parameters, wherein the input includes input that selects which elements to include on the timeline and how to display the elements;
timeline logic configured to:
upon receiving a request to display the timeline with tax account information for an entity:
configure the timeline by consolidating a history of tax account information for the entity in a single display of the timeline, wherein elements in the history are selected based, at least in part, on the parameters; and
dynamically rendering the timeline as one of multiple display zones on a display screen based on the parameters, wherein rendering the timeline includes determining how to display each of the elements on the timeline, and wherein the multiple zones display tax account information about the entity from a tax authority.

9. The computing system of claim 8, wherein the timeline logic is configured to screen elements from being displayed on the timeline based, at least in part, on the parameters and a security level of a user.

10. The computing system of claim 8, wherein the interface logic is configured to generate the interface to expose the parameters that are embedded in logic of the computing system and are protected from being modified without the interface.

11. The computing system of claim 8, wherein the tax information includes collection cases, audit cases, appeal cases, statuses of cases, tax forms, tax form statuses, and payment plan information, tax transactions for the entity, and tax activities for the entity.

12. The computing system of claim 8, wherein the elements include configurable algorithms for customizing display of the tax information on the timeline, and wherein the configurable algorithms each include a plurality of selectable options that are displayed on the interface.

13. The computing system of claim 8, wherein the timeline logic is configured to configure the timeline by consolidating the history of tax account information for a selected time period defined by the parameters.

14. The computing system of claim 8, wherein the parameters include parameters that control which icons are displayed on the timeline and parameters that control which colors displayed on the timeline.

15. A method, comprising:
configuring, by at least a processor, a timeline of tax account information for an entity by consolidating a history of the tax account information for the entity in a display of the timeline, wherein elements in the history are selected based on parameters that have been customized for a revenue authority, wherein the elements include display properties of the timeline and tax account information; and
dynamically rendering, by the processor, the timeline as one of multiple display zones on a display screen based, at least in part, on the parameters, wherein rendering the display includes determining how to display each of the elements on the timeline, wherein the processor configures the timeline and dynamically renders the timeline in response to receiving a request to display the timeline about the entity, and wherein the multiple zones display tax account information about the entity from a tax authority.

16. The method of claim 15, further comprising:
prior to configuring the timeline, generating an interface for customizing the timeline, wherein the interface exposes parameters for modifying the elements of the timeline.

17. The method of claim 16, further comprising:
prior to configuring the timeline, receiving input through the interface to modify the parameters, wherein the input includes input that selects which elements to include on the timeline and how to display the elements.

18. The method of claim 16, wherein the interface exposes the parameters that are embedded in logic of the timeline and are protected from being modified without the interface.

19. The method of claim 16, wherein the elements include configurable algorithms for customizing display of the tax information on the timeline.

20. The method of claim 19, wherein the configurable algorithms each include a plurality of selectable options that are displayed on the interface.
